(19) United States
(12) Patent Application Publication
(10) Pub. No.: US 2026/0180131 A1
(43) Pub. Date: Jun. 25, 2026

(54) BILAYER BATTERY STRUCTURE

(71) Applicant: FORD GLOBAL TECHNOLOGIES, LLC, Dearborn, MI (US)

(72) Inventor: Benjamin Jason EMLEY, Canton, MI (US)

(21) Appl. No.: 18/987,806

(22) Filed: Dec. 19, 2024

(51) Int. Cl. H01M 50/491; H01M 4/02; H01M 4/04; H01M 4/505; H01M 4/525; H01M 4/58; H01M 4/62; H01M 4/66; H01M 50/486

(52) U.S. Cl. CPC H01M 50/491; H01M 4/0409; H01M 4/0485; H01M 4/505; H01M 4/525; H01M 4/5825; H01M 4/622; H01M 4/625; H01M 4/661; H01M 50/486; H01M 2004/021

(57) ABSTRACT

An electrode assembly for lithium-ion batteries is presented. The electrode assembly includes a metal foil current collector, an active material layer with aligned pores, and an intermediary layer positioned between the current collector and the active material layer. The intermediary layer includes a polymer matrix with active material particles dispersed throughout, forming a network of randomly oriented pores.

### TECHNICAL FIELD

This disclosure relates to battery manufacturing.

### BACKGROUND

Freeze-casting may be used to create porous ceramic coatings on electrodes in lithium-ion batteries, facilitating ion and electron transport from the electrode/separator interface to the metal current collector.

### SUMMARY

An electrode assembly includes a metal foil current collector, an active material layer defining aligned pores, and an intermediary layer adhered to the metal foil current collector and the active material layer, with the intermediary layer including a polymer matrix having active material particles dispersed within the polymer matrix to form a network of randomly dispersed pores. The active material layer may include lithium-ion active material particles selected from a group including lithium nickel cobalt manganese oxide, lithium manganese oxide, lithium iron phosphate, and lithium cobalt oxide. The metal foil current collector may be made of copper or aluminum. The aligned pores within the active material layer may have a diameter ranging from 1 to 10 microns. The intermediary layer may be between 1 and 10 microns in thickness. The polymer matrix of the intermediary layer may include a polymer selected from a group comprising polyvinylidene fluoride, polyacrylonitrile, and polyethylene oxide. The active material particles within the intermediary layer may include conductive additives. The active material particles may be selected from a group including carbon black, graphene, and carbon nanotubes.

A lithium-ion battery electrode includes a current collector foil, a primer layer disposed on the current collector, with the primer layer having a binder network that holds active material particles and defines randomly dispersed voids where no active material particles are present, and an active material layer with directionally aligned channels, with non-channeled portions anchored to the voids of the primer layer. The primer layer may have a thickness of less than 10 microns. The binder network of the primer layer may include a mixture of polyvinylidene fluoride and carboxymethyl cellulose. The directionally aligned channels may have a channel width ranging from 5 to 50 microns. The current collector foil may be textured to increase surface area for adhesion. The active material layer may include a conductive additive selected from a group including carbon black, graphene, and carbon nanotubes.

A method for forming an electrode includes coating a primer layer of active material and a binder onto a metal foil current collector, and freeze-casting an active material slurry onto the primer layer to form a freeze-cast active material layer with an ordered porous structure adhered to the primer layer. The method may further include pre-treating the metal foil current collector to roughen a surface of the metal foil current collector before coating the primer layer. The freeze-casting may include cooling the active material slurry at a rate between 1° C./min and 10° C./min. The freeze-casted active material layer may include lithium nickel manganese cobalt oxide as the active material. The primer layer may be coated onto the metal foil current collector using a doctor blade technique. The freeze-casting step may result in directionally aligned channels with a width of 5 to 50 microns through the active material layer.

### BRIEF DESCRIPTION OF THE DRAWINGS

FIGS. 1A-1B are schematic diagrams of an electrode;

FIG. 2 is a schematic diagram of a freeze-cast electrode with a primer layer; and

FIG. 3 is a flowchart of a manufacturing process for a freeze-cast electrode with a primer layer.

### DETAILED DESCRIPTION

In accordance with this disclosure, detailed embodiments of a bilayer electrode assembly are provided, including the structure and composition of a primer layer with randomly dispersed pores and an active material layer with aligned pores, along with associated manufacturing processes. These embodiments represent an innovative approach to enhancing both adhesion and ion transport within lithium-ion battery electrodes. The figures and descriptions are illustrative and may not depict every possible variation or configuration of the electrode assembly. Certain features may be emphasized or simplified to highlight key aspects of the bilayer electrode structure and its functional components. Therefore, the specific structural and operational details provided are not intended to limit the scope of the invention but to guide those skilled in the art in implementing various embodiments of the claimed invention.

Freeze-casting is a technique used in the fabrication of porous battery electrodes, using the principles of directional solidification and subsequent sublimation to create controlled microstructures. The process begins with the preparation of a slurry comprising active materials, conductive additives, and binders, all suspended in a liquid medium, typically water or an organic solvent. Additives such as dispersants or surfactants are often incorporated to enhance the homogeneity and stability of the slurry. This slurry is then poured into a mold, which determines the overall shape and dimensions of the final electrode.

During the freezing phase, the mold is subjected to a controlled temperature gradient, usually by placing it on a cold surface or in a cold chamber. As the liquid begins to freeze, the solvent forms a solid matrix, with the growth of ice crystals or other solid solvent phases following the direction of the imposed temperature gradient. These growing crystals push the solid components of the slurry into the interstitial spaces, creating a structured network. The size and alignment of the pores in the final electrode are governed by parameters such as the freezing rate, solvent type, and temperature gradient. Slower freezing rates typically result in larger, more uniform pores, while rapid freezing produces smaller, less organized structures.

After freezing, the solvent is removed through sublimation in a freeze-drying step, leaving behind a porous scaffold composed of the electrode materials. This step preserves the pore structure formed during freezing without collapsing the material. The resulting structure often exhibits highly aligned and interconnected pores, which provide pathways for ion and electron transport.

The present disclosure relates to addressing challenges associated with the adhesion of freeze-cast active material layers to metal current collectors. Freeze-casting is an effective technique for creating electrodes with aligned porosity, which facilitates the transport of ions and electrons within the battery structure. An ordered porous structure increases the overall electrochemical performance of a battery, particularly in high-energy-density applications such as electric vehicles. The aligned pores allow for more efficient diffusion of ions through the electrolyte, leading to increased rate performance and overall battery efficiency. Despite the advantages of freeze-casting, there may be poor mechanical adhesion between the freeze-cast layer and the underlying metal current collector. Due to the inherently porous nature of freeze-cast layers, the interface between the active material layer and the smooth surface of the current collector may be weak, resulting in delamination and flaking of the electrode during manufacturing or use.

The disclosure addresses adhesion challenges in freeze-cast electrodes by introducing a mechanically stabilizing sublayer, referred to as a primer layer, which is positioned between the metal foil current collector and the freeze-cast active material layer. This intermediary layer is configured to form an adhesive interface that bonds with both the smooth surface of a metal foil current collector and the porous, freeze-cast layer. The primer layer includes a polymer matrix, within which active material particles are dispersed, creating a network of randomly distributed voids. These voids provide surface area for the freeze-cast material to adhere to, improving the mechanical integrity of the electrode. The inclusion of the primer layer allows the freeze-cast structure to remain securely anchored to the current collector, even under the mechanical and thermal pressures encountered during battery operation.

Composition and thickness of the primer layer may be controlled to ensure that it does not adversely affect the electrochemical performance of the overall electrode. In this regard, the primer layer may be controlled to be relatively thin, typically less than 10 microns, so that it contributes minimally to the overall capacity of the electrode. Instead, the bulk of the capacity is derived from the freeze-cast active material layer, which is configured for maximum energy storage and rate performance.

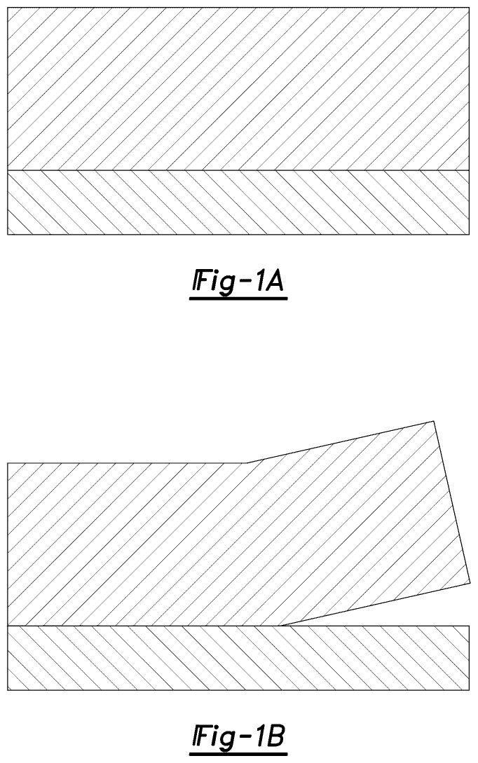

FIGS. 1A and 1B are cross-sectional views of a standard anode coating freeze-cast to a copper (Cu) foil substrate. In FIG. 1A, the anode coating contains randomly oriented porosity, this unaligned structure facilitates mechanical adhesion of the coating to the Cu foil. The distribution of pores allows for a more robust bonding between binder particles and the foil surface. The random porosity provides adequate surface contact and bonding sites, so the coating remains securely attached to the copper substrate.

FIG. 1B shows a cross-sectional view of an anode coating applied using the freeze-casting technique. The coating on the Cu foil has aligned porosity, which results in structured linear pores that may weaken the bonding surface area available for the binder and particles to adhere to the Cu foil. Due to this alignment, there may be insufficient mechanical adhesion at the interface, leading to the coating delaminating or flaking off from the Cu substrate.

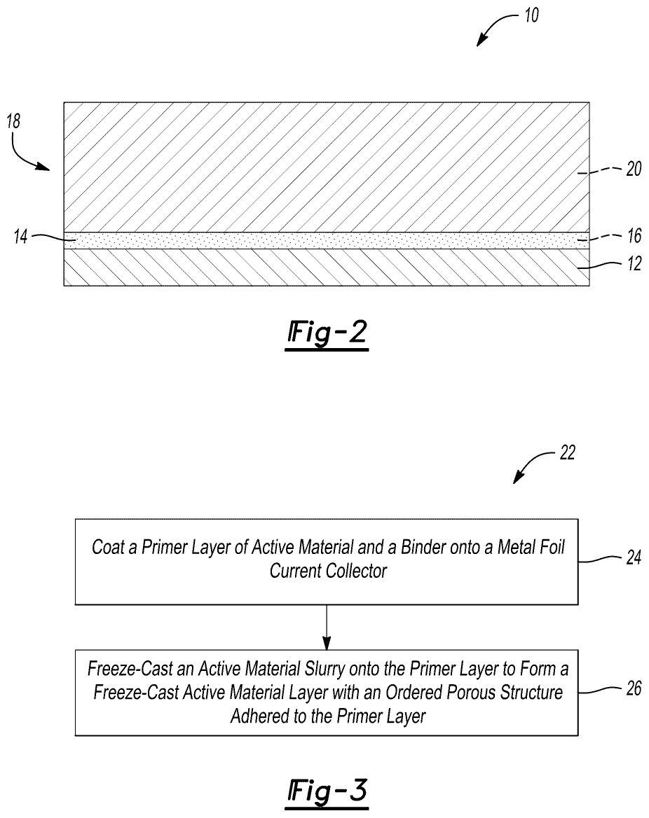

FIG. 2 is an electrode assembly 10 with a metal foil current collector 12, a primer layer 14 with random porosity 16, and an active material layer 18 with aligned porosity 20. The current collector foil 12 may be made from a metal such as Cu or aluminum and may be pre-treated to increase surface roughness, enhancing adhesion to the primer layer. The primer layer 14 is positioned directly on the current collector foil 12 and is formed from a polymer matrix containing dispersed active material particles, creating a network of randomly oriented pores 16. The primer layer 14 acts as an intermediary adhesive layer, increasing the bond between the active material layer 18 and the current collector foil 12, thereby preventing delamination during manufacturing and operation.

A polymer matrix in the primer layer 14 may be made of materials such as polyvinylidene fluoride, polyacrylonitrile, or polyethylene oxide. Active material particles within the primer layer 14 may include conductive additives such carbon black, graphene, or carbon nanotubes for optimal electronic conductivity across the electrode 10. In some implementations, the primer layer 14 may have a thickness of less than 10 microns to provide a compact foundation for the active material layer 18.

Above the primer layer 14 lies the active material layer 18, which is formed through a freeze-casting process that introduces directionally aligned porosity 20. This aligned porosity, characterized by channels or pores with widths ranging from approximately 1 to 10 microns, supports increased ion transport by providing structured pathways for electrolyte diffusion during operation of the electrode 10. The active material layer 18 may include lithium-ion active materials, such as lithium nickel cobalt manganese oxide, lithium manganese oxide, lithium iron phosphate, or lithium cobalt oxide, to enable lithium-ion intercalation and deintercalation during charge and discharge cycles. Additionally, conductive additives, such as carbon black, graphene, or carbon nanotubes, may be incorporated within the active material layer 18 to increase electronic conductivity.

FIG. 3 is a flowchart of a method 22 for manufacturing an electrode assembly by sequentially applying a primer layer and a freeze-cast active material layer onto a metal foil current collector. The first step 24 involves coating a primer layer composed of an active material and a binder onto a metal foil current collector, such as copper or aluminum, using methods like doctor blading. This primer layer serves as a foundational adhesive layer, providing mechanical stability and enhanced bonding between the current collector and subsequent layers.

In the second step 26, an active material slurry is freeze-cast onto the primer layer to form a freeze-cast active material layer with an ordered, porous structure that adheres to the primer layer. During this freeze-casting step, the active material slurry is cooled at a controlled rate, typically between 1° C./min and 10° C./min, to achieve a directionally aligned porous structure within the active material layer. This ordered porosity facilitates ion transport while relying on the underlying primer layer for strong adhesion to the metal foil. The resulting electrode structure enhances both mechanical integrity and electrochemical performance, addressing challenges associated with delamination and ion transport in lithium-ion battery electrodes.

Unless explicitly stated otherwise, all numerical values and ranges in this document, including dimensions, measurements, percentages, weights, and similar numerical references, should be interpreted as preceded by the term “about.” This interpretation applies throughout the disclosure, even where “about” is not specifically mentioned, to account for typical variations in measurement, manufacturing tolerances, material properties, and intended functionality. For example, when a dimension of “10 microns” is stated, it should be understood as “about 10 microns.” Similarly, if the active material layer is specified as having channels with a width of “5 to 50 microns,” it is to be interpreted as “about 5 to about 50 microns.” These variations are inherently included within the intended scope of the invention.

Although specific embodiments, such as the disclosed bilayer electrode assembly with a metal foil current collector, a primer layer with randomly dispersed pores, and an active material layer with aligned pores, are described in detail, they are not intended to limit the invention solely to these configurations. The language used in this disclosure is illustrative and should not be interpreted as restricting the scope of the invention. Variations and modifications can be made without departing from the core principles of the invention. Furthermore, the features and elements of the described bilayer electrode embodiments may be combined in various configurations to create additional embodiments, all of which fall within the scope of the claimed invention, even if such combinations are not explicitly detailed in this document.

What is claimed is:

1. An electrode assembly comprising:
a metal foil current collector;
an active material layer defining aligned pores; and
an intermediary layer adhered to the metal foil current collector and the active material layer, and including a polymer matrix with active material particles dispersed within the polymer matrix to form a network of randomly dispersed pores.

2. The electrode assembly of claim 1 wherein the active material layer comprises lithium-ion active material particles selected from a group comprising lithium nickel cobalt manganese oxide, lithium manganese oxide, lithium iron phosphate, and lithium cobalt oxide.

3. The electrode assembly of claim 1 wherein the metal foil current collector is made of a metal selected from a group including copper and aluminum.

4. The electrode assembly of claim 1 wherein the aligned pores within the active material layer have a diameter ranging from 1 to 10 microns.

5. The electrode assembly of claim 1 wherein the intermediary layer is between 1 and 10 microns.

6. The electrode assembly of claim 1 wherein the polymer matrix of the intermediary layer includes a polymer selected from a group comprising polyvinylidene fluoride, polyacrylonitrile, and polyethylene oxide.

7. The electrode assembly of claim 1 wherein the active material particles within the intermediary layer include conductive additives.

8. The electrode assembly of claim 1 wherein the active material particles are selected from a group comprising carbon black, graphene, and carbon nanotubes.

9. A lithium-ion battery electrode comprising:
a current collector foil;
a primer layer disposed on the current collector foil, the primer layer having a binder network that holds active material particles and defines randomly dispersed voids where no active material particles are present; and
an active material layer with directionally aligned channels, with non-channeled portions anchored to the voids of the primer layer.

10. The lithium-ion battery electrode of claim 9 wherein the primer layer has a thickness of less than 10 microns.

11. The lithium-ion battery electrode of claim 9 wherein the binder network of the primer layer includes a mixture of polyvinylidene fluoride and carboxymethyl cellulose.

12. The lithium-ion battery electrode of claim 9 wherein the directionally aligned channels have a channel width ranging from 5 to 50 microns.

13. The lithium-ion battery electrode of claim 9 wherein the current collector foil is textured to increase surface area for adhesion.

14. The lithium-ion battery electrode of claim 9 wherein the active material layer includes a conductive additive selected from a group comprising of carbon black, graphene, and carbon nanotubes.

15. A method for forming an electrode comprising:
coating a primer layer of active material and a binder onto a metal foil current collector; and
freeze-casting an active material slurry onto the primer layer to form a freeze-cast active material layer with an ordered porous structure adhered to the primer layer.

16. The method of claim 15, further comprising pre-treating the metal foil current collector to roughen a surface of the metal foil current collector before coating the primer layer.

17. The method of claim 15 wherein the freeze-casting includes cooling the active material slurry at a rate between 1° C./min and 10° C./min.

18. The method of claim 15 wherein the freeze-casted active material layer includes lithium nickel manganese cobalt oxide as the active material.

19. The method of claim 15 wherein the primer layer is coated onto the metal foil current collector using a doctor blade technique.

20. The method of claim 15 wherein the freeze-casting results in directionally aligned channels with a width of 5 to 50 microns through the active material layer.
